(19) United States
(12) Patent Application Publication
(10) Pub. No.: US 2008/0270522 A1
(43) Pub. Date: Oct. 30, 2008

(54) SYSTEM AND METHOD FOR LOCATING A DEVICE

(76) Inventor: Slim Souissi, San Diego, CA (US)

Correspondence Address: FOLEY & LARDNER LLP, P.O. BOX 80278, SAN DIEGO, CA, 92138-0278, US

(21) Appl. No.: 11/740,849

(22) Filed: Apr. 26, 2007

(51) Int. Cl. G06F 15/16

(52) U.S. Cl. 709/203

(57) ABSTRACT

A system and method by which a user undertakes a single action in order for location-based services to be enabled and implemented on a device such as a personal computer. According to various embodiments, a “Where am I” or “Locate Me” button or actuator is included on a keyboard or other interface mechanism. When this item is actuated, a position application is invoked, the application sends a request for the device's position to a module, and the module communicates with a network in order to acquire the device's position. Once the positioning information is retrieved, the application exhibits the user's position to the user.

### FIELD OF THE INVENTION

The present invention relates generally to location-based services. More particularly, the present invention relates to systems for implementing and initiating location-based services on a mobile device.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Location-based services are services capable of providing information to a user that is targeted to the user based upon his or her current location. For example, mobile telephone service providers can provide information to a user about restaurants and retail stores that are within the vicinity of the user's current location. In these systems, the mobile phone service provider obtains the user's location from, for example, a global positioning system (GPS) chip that is built into the user's mobile telephone.

As the technology incorporated into devices such as laptop computers continues to advance, such devices will include more and more features. One example of such an advancement is the incorporation of wide area network (WAN) modems supporting GPS functionality into laptop computers. With such capabilities, providers will be able to provide new location-based services to users which were previously difficult or impossible to successfully implement.

Although the ability to provide new and improved location-based services is beneficial, currently the implementation of such services includes a number of shortcomings. For example, current implementations for location-based services require that the end user manually launch a particular application for such services, and then must go through several processes in order for the system to locate the device and display to the user his or her coordinates and selected points of interest. These processes add to the overall complexity in implementing such location-based services.

### SUMMARY OF THE INVENTION

Various embodiments of the invention provide a system and method by which a user undertakes a single action in order for location-based services to be enabled and implemented on a device such as a personal computer. According to various embodiments, a “Where am I” (WRMI) or “Locate Me” button or actuator is included on a keyboard or other interface mechanism. When the user actuates this item, a position application is invoked, the application sends a request for the device's position to a module, and the module communicates with a network in order to acquire the device's position. Once the information is retrieved, the application exhibits the user's position to the user. Selected locations of interest in the area may also be exhibited to the user.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a representation of a system within which embodiments of the present invention may be implemented;

FIG. 2 is a schematic representation of circuitry which may be included in device implementing embodiments of the present invention;

FIG. 3 shows a user interface including a “Where am I” button for use with an embodiment of the present invention;

FIG. 4 is a flow chart showing a process by which embodiments of the present invention maybe implemented; and

FIG. 5 is a representation of a device's display showing a user's location at the end of the implementation of one embodiment of the present invention.

### DETAILED DESCRIPTION OF THE PREFERRED EMBODIMENTS

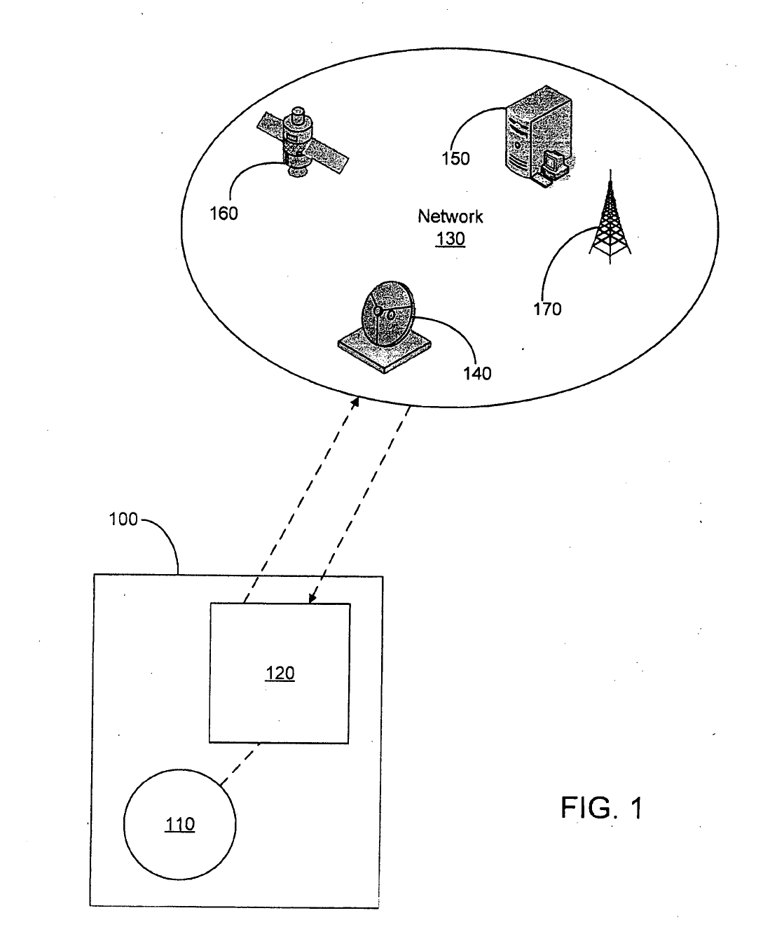

Various embodiments of the invention provide a system and method by which a user undertakes a single action in order for location-based services to be enabled and implemented on a device such as a personal computer. FIG. 1 is a representation of a system within which embodiments of the present invention may be implemented. As shown in FIG. 1, an electronic device 100 communicates with a broader network 130 in order to receive information regarding the location of the electronic device. The electronic device 100 comprises a laptop or notebook computer in one embodiment of the invention, but can also comprise a variety of devices with different general and specific functionalities. The electronic device 100 of FIG. 1 includes a positioning application 110 that is communicatively connected to a positioning module 120, which communicates with the network 130 in order to obtain location information for the electronic device 100. The network 130 may comprise, for example, a GPS network, a cellular network, or another type of network that is capable of determining a device's location and relating such information to the device. Depending upon the network type, the network 130 may comprise various combinations and subcombinations of satellite upload facilities 140, satellites 160, cellular towers 170, various types of control stations 150 and other devices known in the art.

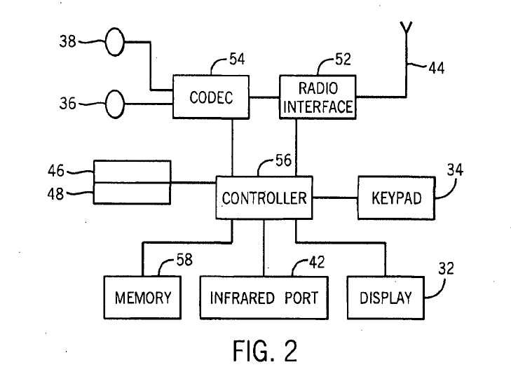

FIG. 2 is a schematic representation of circuitry which may be included in a device implementing embodiments of the present invention. The device circuitry includes a display 32 in the form of a liquid crystal display, a keypad or keyboard 34, a microphone 36, an ear-piece 38, an infrared port 42, an antenna 44, a smart card 46 in the form of a UICC according to one embodiment of the invention, a card reader 48, radio interface circuitry 52, codec circuitry 54, a controller or processor 56 and a memory 58. Individual circuits and elements are all of a type well known in the art.

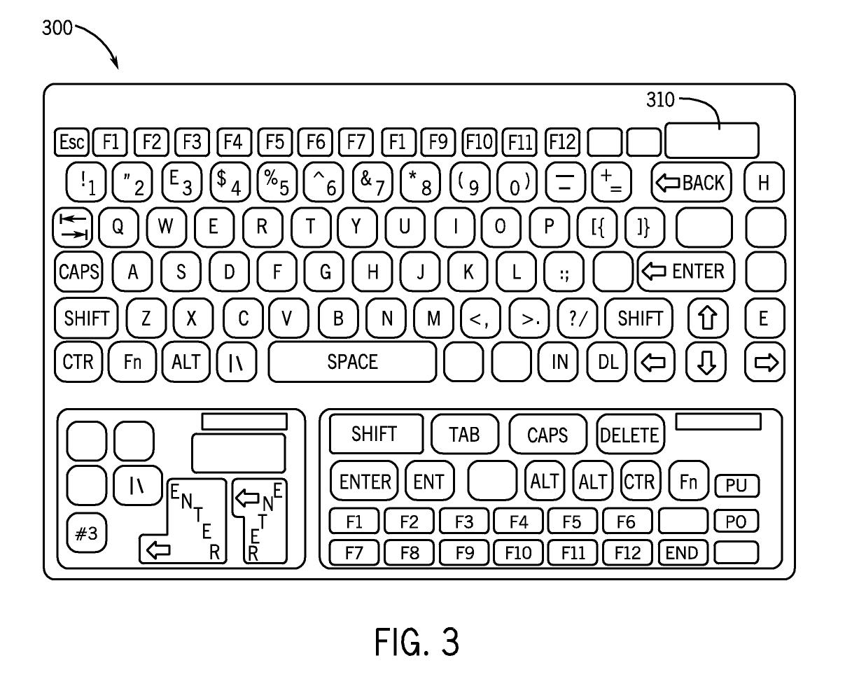

FIG. 3 is a keyboard 300 which may be incorporated on a device implementing embodiments of the present invention. The keyboard in FIG. 3 includes a variety of alphanumeric keys that typically appear on devices such as laptop computers. In addition to these keys, there is also a specific “WRMI” key 310 which enables a user to quickly determine his or her current location according to embodiments of the present invention. The WRMI key, also referred to herein as a “Where am I” or “Locate Me” key, is configured to automatically initiate the positioning program 110 of FIG. 1 upon actuation. The functionality of the WRMI key 310 is incorporated into the applications necessary to retrieve positioning information, such as modem manager applications.

As discussed herein, the WRMI key 310 of FIG. 3 is a single key which possesses no other function. However, it is possible for this key to have other functions as well. For example, if a user were to actuate a “SHIFT” key in tandem with the WRMI key 310, an entirely different function could be initiated. Still further, the WRMI key 310 can essentially be incorporated into another key on the keyboard 300. For example, the functionality of the WRMI key 310 could be implemented via the actuation of simultaneously actuating the “ALT” and “F12” key or some other combination. This arrangement provides the benefit of being able to upgrade an existing device with the WRMI functionality without having to purchase and incorporate a new keyboard 300 into the device. In yet other embodiments of the invention, the WRMI key 310 can be incorporated into something other than a keyboard. For example, the WRMI key 310 can appear as a “virtual” key on a touch-sensitive screen, where the user can use a stylus to actuate the key. In each of these systems, just a single “click” or actuation is necessary to retrieve the desired positioning information.

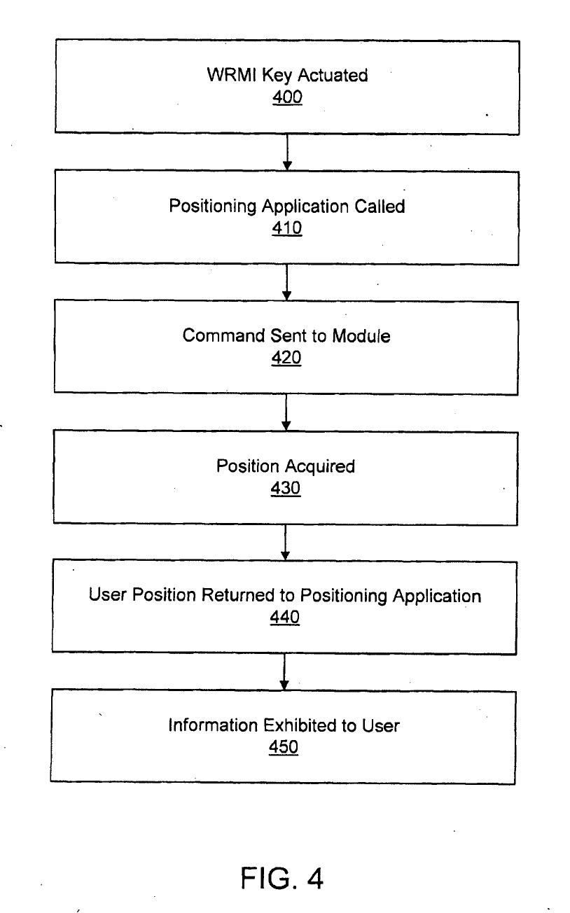

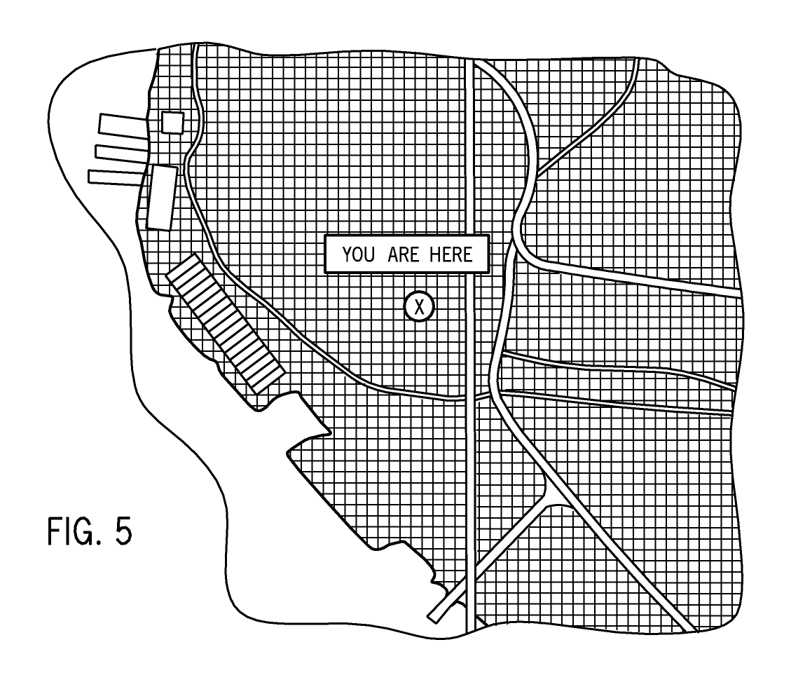

FIG. 4 is a flow chart showing the processes involved in the implementation of various embodiments of the present invention. At 400 in FIG. 4 a user actuates the WRMI key 310 on the device at issue. At 410, the actuation of the WRMI key causes the device to call upon the relevant positioning application. This application can be stored, for example, in the memory unit 58 depicted in FIG. 2. At 420, the positioning application transmits a command to the positioning module 120 to obtain positioning information. At 430, the positioning module 120 proceeds to communicate with the relevant network 130 in order to acquire the position of the device. The exact methods by which the positioning information can be obtained may vary and may include systems such as GPS, Assisted GPS (AGPS) and Cell ID systems, as well as Advanced Forward Link Trilateration (AFLT), Enhanced Observed Time Difference (EOTD), or other cellular triangulation systems. Once the positioning module 120 has retrieved the positioning information, at 440 the positioning module 120 returns the user's position, in terms of GPS coordinates in one embodiment, to the positioning application 110. At 450, the positioning information is exhibited to the user. In one embodiment of the invention, the information is exhibited on a local map on a display for the device, along with other information which may be of interest to the user such as nearby restaurants, stores, attractions, etc. However, the user's position may be exhibited in a variety of other forms known in the art. A sample depiction of a user's location is shown in FIG. 5.

The various embodiments of the present invention described herein is described in the general context of method steps or processes, which may be implemented in one embodiment by a computer program product, embodied in a computer-readable medium, including computer-executable instructions, such as program code, executed by computers in networked environments. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated.

What is claimed is:

1. A method of exhibiting to a device user positioning information for the device, comprising:
receiving an indication of a single actuation by the user;
calling a positioning application in response to the received indication;
retrieving positioning information for the device from a network; and
exhibiting the positioning information for the device to the user.

2. The method of claim 1, wherein the network comprises a global positioning system network.

3. The method of claim 1, wherein the network comprises a cellular network.

4. The method of claim 1, wherein a positioning module is used to retrieve the positioning information, and wherein the positioning application commands the positioning module to retrieve the positioning information.

5. The method of claim 1, wherein the positioning information is exhibited on a display of the device, the display showing the location of the device on a map.

6. The method of claim 1, further comprising exhibiting to the user locations of interest within the vicinity of the device.

7. The method of claim 1, wherein the single actuation comprises the actuation of a single key by the user.

8. The method of claim 1, wherein the device comprises a laptop computer.

9. A device, comprising:
a processor; and
a memory unit communicatively connected to the processor and including:
computer code for processing a received indication of a single actuation by a user;
computer code for calling a positioning application in response to the received indication;
computer code for retrieving positioning information for the device from a network; and
computer code for exhibiting the positioning information for the device to the user.

10. The device of claim 9, wherein the network comprises a global positioning system network.

11. The device of claim 9, wherein the network comprises a cellular network.

12. The device of claim 9, wherein a positioning module is used to retrieve the positioning information, and wherein the positioning application commands the positioning module to retrieve the positioning information.

13. The device of claim 9, wherein the positioning information is exhibited on a display of the device, the display showing the location of the device on a map.

14. The device of claim 9, wherein the memory unit further comprises computer code for exhibiting to the user locations of interest within the vicinity of the device.

15. The device of claim 9, wherein the single actuation comprises the actuation of a single key by the user.

16. The device of claim 9, wherein the device comprises a laptop computer.

17. A method of exhibiting to a user positioning information for a device in the user's possession, comprising:
receiving an indication of a single actuation by the user;
calling a positioning application in response to the received indication;
having the positioning application transmit a command to a positioning module within the device;
in response to the command, having the positioning module retrieve positioning information for the device from a network;
having the positioning module transmit the retrieved positioning information to the positioning application; and
using the positioning application to exhibit the positioning information for the device to the user.

18. The method of claim 17, wherein the device comprises a laptop computer.

19. The method of claim 17, wherein the network comprises a global positioning system network.

20. The method of claim 17, wherein the positioning information is exhibited on a display of the device, the display showing the location of the device on a map.

21. The method of claim 17, wherein the positioning information is transmitted to the positioning application in the form of global positioning system coordinates.
